(19) United States
(12) Patent Application Publication
(10) Pub. No.: US 2024/0006904 A1
(43) Pub. Date: Jan. 4, 2024

(54) Apparatus for Storing Energy and/or Generating Energy, Having a Control Device

(71) Applicant: Siemens Aktiengesellschaft, München (DE)

(72) Inventors: Christian Stahl, Uttenreuth (DE); Alexander Polleti, Nabburg (DE)

(73) Assignee: Siemens Aktiengesellschaft, München (DE)

(21) Appl. No.: 18/249,800

(22) PCT Filed: Oct. 19, 2021
(86) PCT No.: PCT/EP2021/078942

§ 371 Date: Apr. 20, 2023

(30) Foreign Application Priority Data
Oct. 27, 2020 (DE) 10 2020 213 490.1

(51) Int. Cl. H02J 7/00

(52) U.S. Cl. CPC H02J 7/0071; H02J 7/0068; H02J 7/00036; H02J 7/0048; H02J 2310/12; H02J 3/32

(57) ABSTRACT

Various embodiments of the teachings herein include an apparatus for storing energy and/or generating energy. Some examples include: a memory storing at least two control strategies for the apparatus; and a control facility with a microcontroller for controlling the apparatus, wherein the microcontroller executes a control program. The control program carries out operation of the apparatus using a first of the at least two control strategies. The control facility changes the control strategy in response to a trigger, so that following the trigger, the control program carries out operation of the apparatus using a second of the at least two control strategies different from the first. The first control strategy and the second control strategy are stored separately from one another in the memory and separately from the control program in the control facility. The change in the control strategy takes place during the runtime of the control program.

### CROSS-REFERENCE TO RELATED APPLICATIONS

This application is a U.S. National Stage Application of International Application No. PCT/EP2021/078942 filed Oct. 19, 2021, which designates the United States of America, and claims priority to DE Application No. 10 2020 213 490.1 filed Oct. 27, 2020, the contents of which are hereby incorporated by reference in their entirety.

### TECHNICAL FIELD

The present disclosure relates to energy storage. Various embodiments of the teachings herein include systems and/or methods for storing energy and/or generating energy, including using a control strategy.

### BACKGROUND

Energy systems such as battery storage, for example, typically do not follow only a single control strategy in their operation long-term, but rather use different algorithms depending on the situation. Thus, for example, battery storage can be used in the morning to reduce peak loads, in the afternoon to buffer solar power and at night to store electricity at a more favorable rate for the next day. In this case, a change in the control strategies used is possible, for example, via parameterization, i.e. via a change in predefined variables. These can be, for example, the times at which a control strategy is used. Another intervention in the control strategies or the addition of new control strategies is not always immediately possible and requires an interruption of the operation and a software update of the control program.

### SUMMARY

The teachings of the present disclosure describe systems and methods for storing energy and/or generating energy with an improved control facility and an improved operating method for the control facility, whereby the disadvantages mentioned at the outset are reduced. For example, some embodiments include an apparatus (10) for storing energy and/or generating energy, comprising a control facility (24), wherein the control facility (24) has a microcontroller (41) for controlling the apparatus (10), wherein the microcontroller (41) is configured to execute a control program, the control facility (24) is designed to carry out operation of the apparatus (10) using a first of at least two control strategies (101 . . . 104) stored in the apparatus (10), the control facility (24) is configured to change the control strategy (101 . . . 104) in response to a trigger, so that following the trigger, operation of the apparatus (10) is carried out using a second control strategy (102) different from the first, wherein the first and second control strategy (101, 102) are stored separately from one another and separately from the control program in the control facility (24), and the change in the control strategy (101 . . . 104) takes place during the runtime of the control program.

In some embodiments, the control program has an interface (120) which must be implemented by control strategies (101 . . . 104) to be used.

In some embodiments, the first and second control strategy (101, 102) implement the interface (120).

In some embodiments, the control strategies (101 . . . 104) are stored separately as program libraries which can be dynamically integrated in the control facility (24).

In some embodiments, the control facility (24) is designed to use the reaching of a definable time of day, date or month as a trigger.

In some embodiments, the control facility (24) is designed to use an electricity price or an availability of power from renewable sources as a trigger.

In some embodiments, the control facility (24) has a communication interface (25) for establishing a connection to a data network, in particular the Internet (30), the microcontroller (41) is configured to control the communication interface (25), the control facility (24) is configured to use a control signal received from a system connected to the data network, in particular an Internet-based system, as a trigger.

In some embodiments, the control facility (24) is configured to use an Internet-based cloud service (40) as a system connected to the data network.

In some embodiments, the control facility (24) is configured to receive control commands which are embedded in a data packet, wherein the data packet comprises a fourth control strategy (104), and wherein the control facility (24) stores the fourth control strategy (104) received in the data packet in response to the control command.

In some embodiments, the control facility (24) is configured to remove a trigger, upon the occurrence of which there is a switchover to operation with the received control strategy (104), from the data packet.

In some embodiments, the battery storage system (10) comprises an electric storage battery (21).

As another example, some embodiments include an operating method for a control facility for an apparatus (10) for storing energy and/or generating energy, in which the control facility (24) uses a microcontroller (41) for controlling the apparatus (10), wherein a control program is executed on the microcontroller (41), the control facility (24) controls the apparatus (10) using a first of at least two stored control strategies (101, 102), the control facility (24) performs a change of the control strategy (101 . . . 104) in response to a trigger, so that operation of the apparatus (10) following the trigger is performed using a second control strategy (102) different from the first, wherein the first and second control strategy (101, 102) are stored separately from one another and separately from the control program in the control facility (24), and the change in the control strategy (101 . . . 104) is carried out during the runtime of the control program.

### BRIEF DESCRIPTION OF THE DRAWINGS

The teachings of the present disclosure are described and explained in more detail hereinafter with reference to the figures of the diagram in connection with an exemplary embodiment. In the figures:

FIG. 1 shows a building-internal power supply with a battery storage system incorporating teachings of the present disclosure;

FIG. 2 shows the battery storage system at a first time;

FIG. 3 shows the battery storage system at a second time;

FIG. 4 shows the battery storage system and a connected cloud service; and

FIG. 5 shows a class diagram.

### DETAILED DESCRIPTION

The teachings of the present disclosure include an apparatus for storing energy and/or generating energy including a control facility, the control facility having a microcontroller for controlling the apparatus and the microcontroller being configured to execute a control program for this purpose. The control facility is further configured to perform an operation of the apparatus using a first of at least two control strategies stored in the apparatus. In response to a trigger, a change in control strategy is made so that, following the trigger, operation of the apparatus takes place using a second control strategy different from the first.

In this case, the first and second control strategy are stored separately from one another and separately from the control program in the control facility, and the change in control strategy is carried out by the control facility during the runtime of the control program.

As another example, some embodiments of the teachings herein include an operating method for a control facility, wherein the control facility uses a microcontroller for controlling the apparatus, a control program being executed on the microcontroller. Furthermore, the control facility controls the apparatus using a first of at least two stored control strategies. In response to a trigger, a change in the control strategy is made so that, following the trigger, operation of the apparatus is performed using a second control strategy different from the first. The first and second control strategy are stored separately from one another and separately from the control program in the control facility, and the change in control strategy is carried out during the runtime of the control program.

A control strategy includes a set of rules implemented in a programming language for controlling the apparatus. The set of rules can include, for example, the determination of various target values for the charge status of the energy store as a function of influencing variables such as time.

Separate storage means that the control strategies are erasable and overwritable individually as program blocks. In this case, erasable and overwritable mean the practically and feasibly realizable possibility provided, for example, by storage as a separate file in each case. On the other hand, this does not mean the purely theoretical possibility of also removing program parts of a monolithic compiled program, which can only be carried out with great effort. A change in the control strategy during runtime means that the control program does not have to be stopped in order to carry out the change.

These teachings may allow improved operation of an apparatus, in which adaptation or renewal of the control strategies is possible without having to renew the entire control program. Rather, the control program can continue to run while a change in the control strategy takes place and also while an update of a control strategy takes place.

Example embodiments of the teachings herein, including apparatus and methods, emerge from the dependent claims. In this case, embodiments according to one of the independent claims may be combined with the features of one of the subclaims or also with those of a plurality of subclaims. Accordingly, the following features may additionally be present for an apparatus and/or an operating method:

The control program may comprise an interface implemented by control strategies to be used. In object-oriented programming languages, an interface refers to a defined form of public methods, i.e. functions or subprograms which can be called up and are externally visible. A class and its instantiated objects implement this interface if they meet the defined form of public methods, i.e. at least comprise the corresponding methods in the prescribed form. The interface of the control program thus creates a clearly defined interface which can fulfill the control strategies in order to be usable as such.

As a result, it may also be achieved that the development and maintenance of control strategies is decoupled from the development and maintenance of the control program. Thus, the control strategies for example, can be developed and maintained by a different group of developers or in a different company than the control program. Furthermore, this also increases operational reliability as changes in the control strategies do not require changes to the control program but are independent thereof. Changes in the control strategies therefore lead to errors in the control of the apparatus much less easily.

Furthermore, developers of control strategies do not have to be given any insight into the functionality of the apparatus or the control program if this is preferably to be kept secret by the manufacturer.

In some embodiments, the first and second control strategy, which already comprise the control facility, implement the interface described. In the simplest case, the interface can comprise only a single method, for example a method which returns the target point for the charge status of the energy store as a result. In other embodiments, however, the interface can also comprise a plurality of different methods.

In some embodiments, the control strategies are stored separately in the control facility as program libraries which can be dynamically integrated. Such program libraries are known, for example, as “dynamic link libraries” or “shared libraries” in various operating system environments and can be created with available programs on PCs. For example, reaching a definable time of day, a date or a month, that is to say all types of temporal triggers, can be used as the trigger upon which a change of the control strategy used takes place. These triggers allow an adaptation of the control strategy to the main influencing factor, that is to say the time of day. Thus, for example, a different control strategy can be selected at night than during the day.

In addition, the availability of other devices in the local network, that is to say for example, a building network, can also be used as a trigger on an alternative or additional basis. For example, the control strategy may be changed if the power of a PV system is available or is no longer available or if an electrically operated vehicle is connected to the network or is disconnected from the network.

In some embodiments, the availability of power from renewable sources which are not locally assigned to the building network but are connected to the apparatus via the general supply network can also be used as a trigger. Finally, the current electricity price can also be used as a trigger.

In some embodiments, the control facility comprises a communication interface for establishing a connection with a data network, in particular the Internet. Such a communication interface can work in a wired manner, for example, as a LAN port, or wirelessly, for example, as a Wi-Fi interface. The connection to the Internet can be established indirectly, for example, via a router. The microcontroller is expediently designed to control the communication interface, i.e. it controls the receipt and transmission of data packets. Furthermore, the control facility is configured to use a control signal received from a system connected to the data network, in particular an Internet-based system, as a trigger.

In some embodiments, with such a trigger, the change in the control strategies does not take place on the basis of a check or a comparison of a predetermined variable with a threshold variable, as in the use of a time of day as a trigger. Rather, the change in the control strategy takes place as a result of a trigger from outside the apparatus which cannot be foreseen by the apparatus. In this way, the control strategy can be changed, for example by a cloud service. Likewise, the change in the control strategy can take place as a result of a user input on a tablet PC, by means of which a corresponding control signal is generated. In this case, the control program itself does not have to be configured to query the user input directly, i.e. to provide a user interface. Rather, the control program acts only as a receiver. This ensures that the decision about the change in control strategy is shifted from the apparatus to an external location, for example a cloud service. This makes it easier to adapt the change between the control strategies to altered conditions. This also makes it possible to make these decisions for a plurality of devices at the same time. These devices can form a network such as, for example, a virtual power plant (VPP).

In some embodiments, the control facility is configured to receive control commands which are embedded in a data packet, the data packet also comprising a control strategy, and the control facility storing the control strategy received in the data packet in response to the control command. As a result, it is possible to transmit new control strategies or modified versions of already existing control strategies, i.e. updates, to the apparatus. The control facility stores the transmitted control strategy and thereby overwrites an already existing control strategy if it is an update. In this case, it is particularly advantageous that the control program per se does not have to be changed or interrupted when running.

In some embodiments, the control facility can also be configured to remove a trigger, upon the occurrence of which there is a switchover to operation with the received control strategy, from the data packet. Its implementation can also be controlled, for example, by an interface with a suitable method, so that use by an unchanged control program is made possible.

The teachings of the present disclosure and the various example embodiments described herein make it possible to assemble a battery storage system which comprises an electric storage battery.

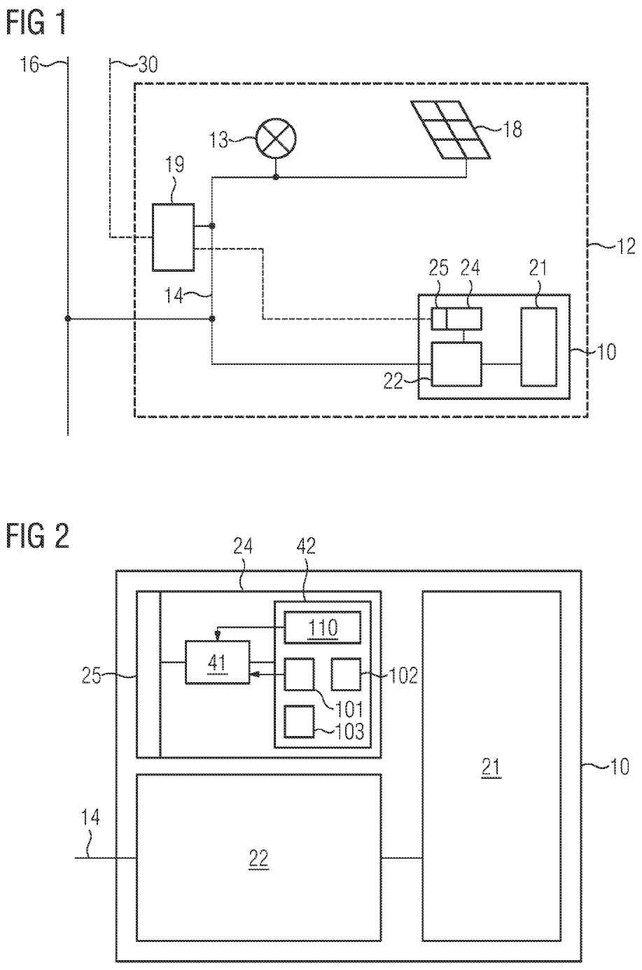

FIG. 1 shows a battery storage system 10 which is connected in a building 12 to the building-internal power supply 14 and, in addition, indirectly to the supply network 16. In addition to the usual consumers such as lighting 13 and other electrical devices, the exemplary building also comprises a photovoltaic system 18 which is connected to the building-internal power supply 14 and is therefore likewise connected to the battery storage system 10.

The battery storage system 10 itself comprises the actual electrical chargeable and dischargeable storage battery 21 and a power converter 22 which is connected between external connections 23 and the storage battery 21 and carries out an inversion and rectification depending on the power flow. Furthermore, the battery storage system 10 comprises a control facility 24 which is configured to control the power converter 22 and all other components of the battery storage system 10. Part of the control facility 24 is also a communication interface 25 which enables the control facility 24 to be connected to the Internet 30. In this example, the communication interface 25 is a LAN interface (LAN=local area network) which enables a connection to a router 19 in a wired manner, the router 19 establishing the actual connection to the Internet 30. In other embodiments, the communication interface 25 can also enable a wireless connection, for example, as a WLAN interface or via a Bluetooth connection.

FIG. 2 shows the battery storage system 10 at a first operating time, the control facility 24 being shown in greater detail in FIG. 2 than in FIG. 1. In addition to the communication interface 25, the control facility 24 comprises a microcontroller 41 (also referred to as MCU=microcontroller unit) and a memory 42. A control program 110 and three different control strategies 101 . . . 103 are stored as separate files in the memory 42. During operation, the microcontroller 41 executes the control program 110. As the microcontroller 41 has limited computing and processing capacity and limited memory in comparison with modern MPUs (microprocessor unit or microprocessor), the control program 110 in the memory 42 is expediently present in a compiled form which can be executed directly by the microcontroller 41.

The control program 110 is designed such that the battery storage system 10 is controlled and/or regulated according to one of the control strategies 101 . . . 103. In some embodiments, the control program 110 is configured such that it does not contain the control strategy 101 . . . 103 and is therefore not monolithic in configuration. Rather, the control strategies 101 . . . 103 are present separately from the control program 110 and separately from one another and can be dynamically integrated by the control program 110.

In some embodiments, the control strategies are not firmly anchored in the source code of the control program 110, but rather are addressed as separate objects. One of these objects, namely the one whose control strategy 101 . . . 103 is to be used, is integrated into the sequence by the control program 110 during its runtime by calling its methods as required, for example, a method for determining a charge status which is ideal at a time. Method in this context refers to a function or subroutine of an object.

In order to enable such a dynamic connection of the control strategies 101 . . . 103 and thus of the objects connected to them, a fixed rule may be defined for the objects, which methods must be present and which input parameters and output parameters are used. Such a rule is referred to as an interface in programming languages such as C# and Java. This strategy interface is met by the stored control strategies and, as a result, these can be dynamically integrated into the control sequence during the runtime of the control program 110.

At the first operating time, which is, by way of example, a time in the morning of any given day, the control program 110 uses the first control strategy 101 to regulate the battery storage system 10. In this example, the first control strategy 101 is designed such that the battery storage system 10 contributes to the reduction of peak loads. In the first control strategy 101, an output of electrical power is therefore preferred to full charging of the storage battery 21.

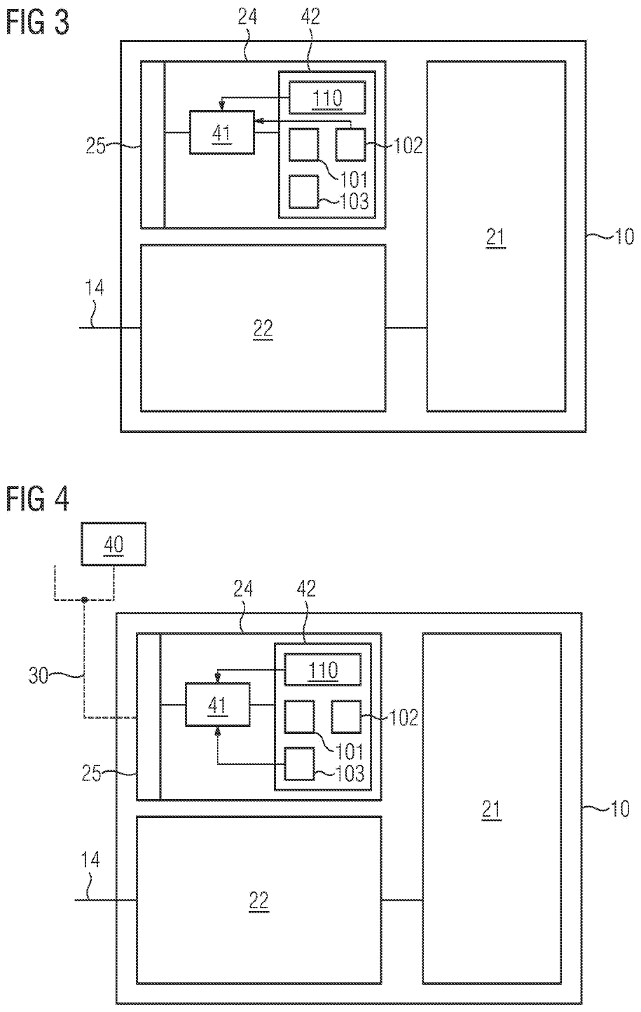

FIG. 3 shows the battery storage system 10 at a second operating time, which in this example is a time in the afternoon of the same day. At this time, the control program 110 uses the second control strategy 102 for operating the battery storage system 10. The second control strategy 102 provides for buffering of solar power for the battery storage system 10. This means that at this second operating time, charging of the battery 102 is preferred to a power output, though the charging should not take place from the supply network 16, but from the photovoltaic system 18.

When switching from the first to the second control strategy 101, 102, the object corresponding to the first control strategy 101 is replaced in the control program by one from the second control strategy. All calls of methods of the control strategy are thereby processed automatically and without interruption by the second control strategy 102 from the time of the switchover. The replacement of the first control strategy 101 by the second control strategy 102 takes place in this case by changing a stored pointer, that is to say a reference to a specific location (address) in the memory 42 of the microcontroller 41. At the first time, this pointer points to the address of the object corresponding to the first control strategy 101. This address is changed for the switchover so that the pointer now points to the address of the object representing the second control strategy 102.

At a third operating time not shown in the figures, the third control strategy 103 is integrated into the operation of the battery storage system 10 in an analogous manner. The third control strategy 103 can be used, for example, at night and results in the storage of electricity at a more favorable rate for the next day, i.e. for charging of the storage battery 21 from the supply network 16.

In principle, the described sequence would also be possible with a control program 110 in which the control strategies 101 . . . 103 are fully integrated. In some embodiments, the separate storage of the control strategies 101 . . . 103 and their dynamic integration by the control program 110 makes it possible to change one or more of the control strategies during operation, i.e. to carry out an update without having to interrupt and change the control program itself. For example, it is thus possible to adapt one of the control strategies to changes in the circumstances, such as tariff changes or other new operating conditions, without necessitating an interruption of the operation and an update of the entire firmware. The control strategy per se can be overwritten, for example, by the new version.

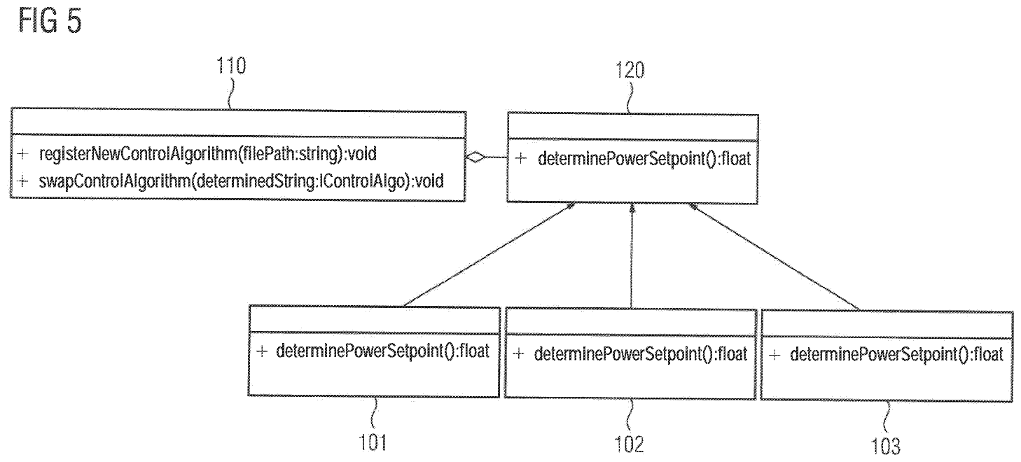

A further advantage of the embodiment described is explained in connection with FIG. 4. In addition to the battery storage system 10, FIG. 4 shows a cloud service 40. Cloud service 40 is accessible via the Internet and is connected to the control facility 24 via the Internet. At a fourth operating time, the cloud service 40 sends a message 45 to the control facility 24 via the Internet. The message 45 contains a control command 46 and a fourth control strategy 104. The fourth control strategy can be focused, for example, on charging a locally connected electric vehicle from battery storage late at night. Like the first to third control strategy, the fourth control strategy 104 is individually compiled and can be stored in the memory 42.

The control facility 24 receives the control command 46 and the fourth control strategy 104 and processes both. In this case, the control command 46 contains a call to a method of the control program 110 provided for this purpose, with which a new or changed control strategy 104 is registered in the control program and included in the control strategies used. This method, which can be called registerNewControlAlgorithm( ) in a program, for example, contains the strategy itself as an input parameter. The supplied strategy must meet the strategy interface already described in order to be used.

Further input parameters can be, for example, time limits within which the new control strategy 104 is to be used. After the control facility 24 has stored the new control strategy 104, it is dynamically integrated into the operating sequence by the registration. Again, this happens without a firmware update. As a result, the switchover happens without disruptive interruption and without the problems which can occur during the firmware update if, for example, the performance of the update is interrupted.

In some embodiments, new and modified control strategies can thus be adopted in operation in this way, it being possible for this to be controlled in a decentralized manner, for example by means of an Internet-based cloud service 40. Another example of a control strategy added later is a strategy by means of which a purchasable reserve service is made available to other participants of a local energy market in a selected time frame.

FIG. 5 shows a class diagram which shows the relationship between the control program 110 and the control strategies 101 . . . 103. The control strategies 101 . . . 103 implement the interface 120 which prescribes a method with the name determinePowerSetpoint( ). In addition to the method already described, registerNewControlAlgorithm( ), the control program 110 also comprises the method swapControlAlgorithm( ), with which a new control strategy 101 . . . 104 is selected for ongoing operation. The method swapControlAlgorithm( ) requires an object which implements the interface 120 as an input parameter.

### LIST OF REFERENCE CHARACTERS

10 Battery storage system
12 Building
13 Lighting
14 Power supply
16 Supply network
18 Photovoltaic system
19 Router
21 Storage battery
22 Power converter
23 External connections
24 Control facility
25 Communication interface
30 Internet
40 Cloud service
41 Microcontroller
42 Storage
45 Message
46 Control command
101 . . . 104 Control strategies
120 Interface

What is claimed is:

1. An apparatus for storing energy and/or generating energy, the apparatus comprising:
a memory storing at least two control strategies for the apparatus;
a control facility
with a microcontroller for controlling the apparatus, wherein the microcontroller executes a control program;
wherein the control program carries out operation of the apparatus using a first of the at least two control strategies;
the control facility changes the control strategy in response to a trigger, so that following the trigger, the control program carries out operation of the apparatus using a second of the at least two control strategies different from the first;
wherein the first control strategy and the second control strategy are stored separately from one another in the memory and separately from the control program in the control facility; and
the change in the control strategy takes place during the runtime of the control program.

2. The apparatus as claimed in claim 1, in which the control program has an interface implemented by control strategies to be used.

3. The apparatus as claimed in claim 2, wherein the first and second control strategy implement the interface.

4. The apparatus as claimed in claim 1, wherein the control strategies are stored separately as program libraries which can be dynamically integrated in the control facility.

5. The apparatus as claimed in claim 1, wherein the control facility is designed to use the reaching of a definable time of day, date, or month as a trigger.

6. The apparatus as claimed in claim 1, wherein the control facility uses an electricity price or an availability of power from renewable sources as a trigger.

7. The apparatus as claimed in claim 1, wherein
the control facility includes a communication interface for establishing a connection to a data network;
the microcontroller controls the communication interface; and
the control facility is configured to use a control signal received from a system connected to the data network as a trigger.

8. The apparatus as claimed in claim 1, wherein the control facility uses an Internet-based cloud service as a system connected to the data network.

9. The apparatus as claimed in claim 1, wherein:
the control facility receives control commands embedded in a data packet;
the data packet comprises a fourth control strategy; and
the control facility stores the fourth control strategy received in the data packet in response to the control command.

10. The apparatus as claimed in claim 9, wherein the control facility removes a trigger, upon the occurrence of which there is a switchover to operation with the received control strategy, from the data packet.

11. The apparatus as claimed in claim 1, further comprising an electric storage battery.

12. A method for operating a control facility for an apparatus for storing energy and/or generating energy, the method comprising:
using a microcontroller to control the apparatus by executing a control program;
controlling the apparatus using a first of at least two stored control strategies; and
performing a change of the control strategy in response to a trigger, then controlling the apparatus following the trigger using a second control strategy different from the first;
wherein the first control strategy and the second control strategy are stored separately from one another and separately from the control program in the control facility, and the change in the control strategy is carried out during the runtime of the control program.
